(19) United States
(12) Patent Application Publication
(10) Pub. No.: US 2021/0341347 A1
(43) Pub. Date: Nov. 4, 2021

(54) PRESSURE DETECTION SIGNAL PROCESSING DEVICE, ENGINE CONTROL SYSTEM, AND PROGRAM

(71) Applicant: MIKUNI CORPORATION, Tokyo (JP)

(72) Inventors: Satoru FUJISAKI, Iwate (JP); Katsuhiko FUKUI, Iwate (JP)

(73) Assignee: MIKUNI CORPORATION, Tokyo (JP)

(21) Appl. No.: 17/283,024

(22) PCT Filed: Nov. 19, 2018
(86) PCT No.: PCT/JP2018/042614

§ 371 Date: Apr. 6, 2021

(51) Int. Cl. G01L 23/22; G05B 11/01; G05B 11/12; F02D 35/02; F02D 41/14

(52) U.S. Cl. CPC G01L 23/226; G01L 23/222; G05B 11/011; G05B 11/12; F02D 2200/101; F02D 41/1401; F02D 2041/1432; F02D 2041/1409; F02D 35/023

(57) ABSTRACT

The objective of the present invention is to remove drift of a piezoelectric element and thereby obtain a highly precise pressure detection signal by means of a simple configuration. A pressure detection signal processing device 200 includes: a charge amplifier 210 that accumulates electric charge produced by a piezoelectric element 35 in response to a received pressure and outputs a corresponding voltage signal; drift component extraction units 230 and 240 that extract a drift component of the piezoelectric element 35 by performing differential processing on the voltage signal; and a drift correction unit 250 that generates, based on the extracted drift component, a correction signal for removing the drift component and feeds the correction signal back to an input side of the charge amplifier.

### BACKGROUND

### Technical Field

The present invention relates to a pressure detection signal processing device which performs signal processing on a pressure detection signal from a pressure sensor that includes a piezoelectric element, and relates to an engine control system and a program.

### Related Art

Conventionally, a configuration is proposed which includes a charge amplifier as a signal processing circuit for a pressure detection signal from a pressure sensor using a piezoelectric element that outputs an electric charge corresponding to pressure receiving strength. The charge amplifier has a configuration in which a feedback resistor and a feedback capacitor are connected in parallel with an operational amplifier, and the operational amplifier is in negative feedback connection.

In this signal processing circuit, a leakage electric current of the piezoelectric element becomes a drift of the pressure detection signal, and thus it is necessary to arrange a drift correction circuit or the like for eliminating an influence of the drift.

As an example of the correction circuit, a circuit is proposed which uses a reset signal synchronized with a rotation signal of a crankshaft to eliminate the influence of the drift (for example, see Patent literature 1). However, a reset timing detection unit arranged in the correction circuit determines whether or not a reset timing is a scheduled reset timing in an intake stroke based on output of a crank angle sensor, outputs a reset signal when the scheduled reset timing is reached, and resets the output of the charge amplifier to zero. Therefore, a circuit system of the pressure detection signal processing circuit becomes complicated. Moreover, if output precision of the crank angle sensor is not ensured, the reset cannot be performed precisely.

Therefore, a circuit configuration is proposed in which a direct current isolator is interposed between a piezoelectric element and a charge amplifier. The direct current isolator interrupts a direct current component and makes the pressure detection signal pass through, and is configured by a capacitor (for example, see Patent literature 2). That is, although the leakage electric current of the piezoelectric element acts as the drift, the leakage electric current can also be regarded as the direct current component which maintains a stable magnitude even for a relatively long time, and thus the direct current component is interrupted by the capacitor.

### LITERATURE OF RELATED ART

### Patent Literature

Patent literature 1: Japanese Patent Laid-Open No. 2002-242750 (Pages 3 to 6, FIG. 10)

Patent literature 2: Japanese Patent Laid-Open No. 2009-115484 (Pages 2 to 7, FIG. 1)

### SUMMARY

### Problems to be Solved

However, according to the configuration of Patent literature 1, a capacitance of a capacitor which is a direct current isolator depends on a magnitude of impedance of the piezoelectric element. Therefore, there is a problem that the capacitance of the capacitor may become large when the impedance of the piezoelectric element is small. In addition, there is a problem or the like that a mounting area of the capacitor on a surface of the electronic substrate may increase when the capacitance of the capacitor increases.

The present invention is accomplished to solve the conventional problem and has an objective to provide a pressure detection signal processing device capable of removing drift of a piezoelectric element and thereby obtaining a highly precise pressure detection signal by means of a simple configuration, and to provide an engine control system and a program.

### Means to Solve Problems

In order to achieve the objective described above, a pressure detection signal processing device according to an aspect of the present invention is a device which performs signal processing on an output signal of a pressure sensor that includes a piezoelectric element producing an electric charge corresponding to a received pressure, and includes:
a charge amplifier which accumulates the electric charge and outputs a corresponding voltage signal;
a drift component extraction unit which extracts a drift component of the piezoelectric element by performing differential processing on the voltage signal; and
a drift correction unit which generates a correction signal for removing the extracted drift component and feeds the correction signal back to an input side of the charge amplifier.

In addition, the drift component extraction unit may include:
a differential processing unit which performs the differential processing on the voltage signal; and
a low-pass filter which extracts a component in a predetermined low frequency band of the signal which has been subjected to the differential processing. In addition, the charge amplifier may include an operational amplifier which is in negative feedback connection to a parallel circuit consisting of a resistor and a capacitor or is in negative feedback connection to a capacitor.

In addition, the drift correction unit may include:
a first difference calculation unit which calculates a first difference between a first target value set previously and the extracted drift component; and
a correction processing unit which generates the correction signal corresponding to the first difference and feeds the correction signal back to the input side of the charge amplifier.

Furthermore, in order to perform P control, the pressure detection signal processing device may further include: a second low-pass filter which extracts a signal showing a component in a predetermined low frequency band of the voltage signal;
a second difference calculation unit which calculates a second difference between a second target value set previously and the signal extracted by the second low-pass filter; and
a proportional processing unit which outputs a proportional signal obtained by performing proportional processing on the second difference, wherein
the correction processing unit may generate the correction signal corresponding to an addition signal obtained by adding the proportional signal to the first difference and feed the correction signal back to the input side of the charge amplifier, and the charge amplifier may output the correction signal.

Besides, in order to perform I control, the pressure detection signal processing device may further include: a third difference calculation unit which calculates a third difference between the second target value and the signal extracted by the second low-pass filter; and
an integral processing unit which outputs an integral signal obtained by performing integral processing on the third difference, wherein
the correction processing unit may generate the correction signal corresponding to an addition signal obtained by adding the first difference, the proportional signal, and the integral signal, and feed the correction signal back to the input side of the charge amplifier.

A slice unit which slices an input signal exceeding a predetermined value to the predetermined value may be arranged in a front stage of the differential processing unit and/or a front stage of the second low-pass filter.

In addition, in order to perform PID control,
the drift component extraction unit may include:
a low-pass filter which extracts a signal showing a component in a predetermined low frequency band of the voltage signal, and
a differential processing unit which outputs a differential signal obtained by performing differential processing on the signal extracted by the low-pass filter;
the drift correction unit may include:
a first difference calculation unit which calculates a first difference between a first target value set previously and the differential signal, and
a correction processing unit which generates the correction signal and feeds the correction signal back to an input side of the charge amplifier;
the pressure detection signal processing device may include:
a second difference calculation unit which calculates a second difference which is a difference between a second target value set previously and the signal extracted by the low-pass filter,
a proportional processing unit which outputs a proportional signal obtained by performing proportional processing on the second difference, and
an integral processing unit which outputs an integral signal obtained by performing integral processing on the second difference; and
the correction processing unit may generate the correction signal corresponding to an addition signal obtained by adding the first difference signal, the proportional signal, and the integral signal.

In addition, in order to perform engine control using a pressure detection signal, an engine control system may be configured which includes the pressure detection signal processing device, and a control unit which performs control of an engine based on an output signal from the pressure detection signal processing device. In addition, a digital signal processing unit may change a cut-off frequency of the low-pass filter according to a rotation speed of the engine.

A program according to another aspect of the present invention is a program for achieving, in a pressure detection signal device which performs signal processing on an output signal of a pressure sensor containing a piezoelectric element producing an electric charge corresponding to a received pressure, an extraction function for extracting a drift component of a piezoelectric element by performing differential processing on a voltage signal from a charge amplifier which accumulates an electric charge and outputs the corresponding voltage signal; and
a correction function for generating a correction signal for removing the extracted drift component, and feeding the correction signal back to an input side of the charge amplifier.

In addition, the correction function may include: a difference calculation function for calculating a difference between a target value set previously and the drift component extracted by the extraction function; and a correction processing function for feeding the correction signal corresponding to the difference back to the input side of the charge amplifier.

### Effect

According to the present invention, an effect is obtained that a pressure detection signal processing device, an engine control system, and a program can be provided which are capable of removing drift of a piezoelectric element and thereby obtaining a highly precise pressure detection signal by means of a simple configuration.

### BRIEF DESCRIPTION OF THE DRAWINGS

FIG. 1 is a schematic illustration diagram showing a configuration of an engine control system 300.

FIG. 2 is a function configuration diagram of an ECU 100.

FIG. 3 is a configuration of a pressure detection signal processing device 200.

FIG. 4 is a schematic configuration diagram of a pressure sensor 30.

FIG. 5 is a configuration diagram of a charge amplifier 210.

FIG. 6 is a configuration diagram of a digital signal processing unit 220 of a first aspect.

FIG. 7 is a configuration diagram of a correction processing unit 252.

FIG. 8 is a configuration diagram of a digital signal processing unit 220 of a second aspect.

FIG. 9 is a configuration diagram of a correction processing unit 252 of another aspect.

FIG. 10 is a configuration diagram of a digital signal processing unit 220 of a third aspect.

FIG. 11 is a schematic illustration diagram of PID control.

FIG. 12 is an illustration diagram of operations of the pressure detection signal processing device 200.

FIG. 13 is a graph showing a comparative example between a conventional example and the present invention.

### DESCRIPTION OF THE EMBODIMENTS

An embodiment of the present invention is described below with reference to the drawings. The embodiment of the present invention described below is an example, the present invention is not limited to the following embodiment, and various modifications and changes can be made with respect to the following embodiment.

(Summary of Engine Control System 300)

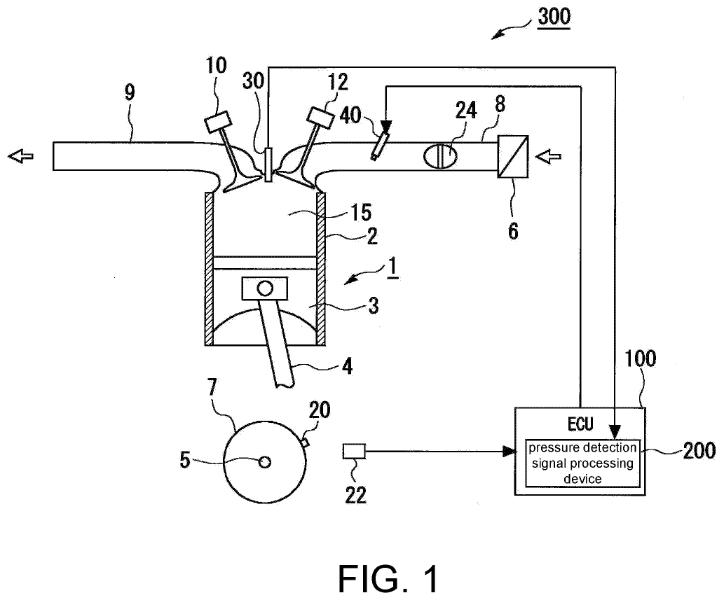

FIG. 1 is a schematic configuration diagram of an engine control system 300 including an engine 1 and an electric control unit (ECU) 100. The engine control system 300 uses a pressure detection signal which has been subjected to signal processing by a pressure detection signal processing device 200 to perform engine control. The “pressure detection signal” is an output signal from a pressure sensor 30. Moreover, in FIG. 1, an ignition plug is not shown for ease of understanding.

The engine 1 has a cylinder 2, and a piston 3 which is fitted to be slidable in an up-down direction inside the cylinder 2. An end side of a connecting rod 4 is connected to the piston 3, and the other end side of the connecting rod 4 is connected to a crankshaft 5. A flywheel 7 is rotatably connected to an end portion of the crankshaft 5 on a transmission side (not shown). A retractor 20 which is a protrusion made of a magnetic material is formed in a predetermined angle region on an outer circumference of the flywheel 7.

An electromagnetic pickup 22 which is arranged to face the crankshaft 5 outputs a positive voltage pulse when the retractor 20 approaches, and outputs a negative voltage pulse when the retractor 20 moves away. When the pulse is shaped based on a positive pulse signal or a negative pulse signal by a known pulse shaping circuit in order that one rectangular pulse is output, one rectangular pulse is output for each rotation of the flywheel 7.

Thus, because the crankshaft 5 rotates by 720° in a cycle of “intake→compression→combustion→exhaust”, a 2-pulse rectangular signal (an engine rotation signal) is output from the electromagnetic pickup 22 in one circle. In this way, the electromagnetic pickup 22 serves as a crank angle sensor that detects the rotation angle of the crankshaft 5.

As a result, a rotation speed of the engine 1 can be calculated based on the engine rotation signal from the electromagnetic pickup 22. In addition, a position where the retractor 20 is formed on the outer circumference of the flywheel 7 can be set to an appropriate angle region, and a timing when an ignition control signal is given to the ignition plug to ignite fuel can be set to a desired timing based on the engine rotation signal from the electromagnetic pickup 22. The desired timing is a timing corresponding to a top dead center (TDC), an advance angle (BTDC) side from the top dead center, or a retard angle (ATDC) side from the top dead center.

In addition, an intake pipe 8 and an exhaust pipe 9 are connected to a cylinder head above the cylinder 2. An inside of the intake pipe 8 is an intake passage for taking in fresh air from the outside into the combustion chamber 15. In addition, an air cleaner 6 for removing fresh air dust and the like, a throttle valve 24 for adjusting an intake amount of the fresh air, an injector 40 for injecting the fuel, and the like, are arranged in the intake passage from an upstream side. Besides, a timing of taking in the fresh air into the combustion chamber 15 is controlled by a valve opening/closing operation of an intake valve 12 which is urged in a valve closing direction by a spring (not shown).

Besides, the pressure sensor 30 detects a combustion pressure which is a pressure of the combustion chamber 15, and outputs a pressure detection signal showing the detected combustion pressure. The pressure sensor 30 is arranged at the top portion of the cylinder head with a front end of the pressure sensor 30 facing the inside of the combustion chamber. Moreover, the mounting position of the pressure sensor 30 is not limited to the position shown in FIG. 1. Similarly, the ignition plug (not shown) is also arranged at an appropriate position at the cylinder head with a front end of the ignition plug facing the inside of the combustion chamber. The pressure sensor 30 can also be integrally arranged inside the ignition plug, or the pressure sensor 30 and the ignition plug can also be arranged separately.

On the other hand, an inside of the exhaust pipe 9 is an exhaust passage for exhausting exhaust gas from the combustion chamber 15. Besides, a timing of exhausting the exhaust gas from the combustion chamber 15 is controlled by a valve opening/closing operation of an exhaust valve 10 which is urged in the valve closing direction by a spring (not shown).

The signals from the electromagnetic pickup 22, the pressure sensor 30, and the like are input to the ECU 100 which controls the operation of the engine 1. The rectangular pulse signal corresponding to the engine rotation is input from the electromagnetic pickup 22. The pressure detection signal is input from the pressure sensor 30. On the other hand, the ECU 100 controls the fuel injection of the injector 40 and controls the ignition of the ignition plug.

Besides, the pressure detection signal from the pressure sensor 30 is subjected to the signal processing by the pressure detection signal processing device 200. The ECU 100 controls the fuel injection (an injection amount and an injection time) by the injector 40 and controls the ignition time by the ignition plug based on the engine rotation signal and the pressure detection signal which has been subjected to the signal processing by the pressure detection signal processing device 200.

A reciprocating motion of the piston 3 inside the cylinder 2 in the up-down direction is converted into a rotation motion of the crankshaft 5. The rotation motion of the crankshaft 5 is transmitted to drive wheels via a transmission machine, and a vehicle (having two wheels or four wheels) moves forward by repeating the stroke of “intake→compression→combustion→exhaust”.

Moreover, FIG. 1 is a configuration example of the engine 1 and the ECU 100 controlling the engine 1. For example, in addition to the engine rotation signal and the pressure detection signal, the ECU 100 can also control the engine 1 with reference to an intake temperature, a cooling water temperature, an oxygen concentration in the exhaust gas, a throttle opening, and the like of the engine 1.

(Function Configuration of ECU 100)

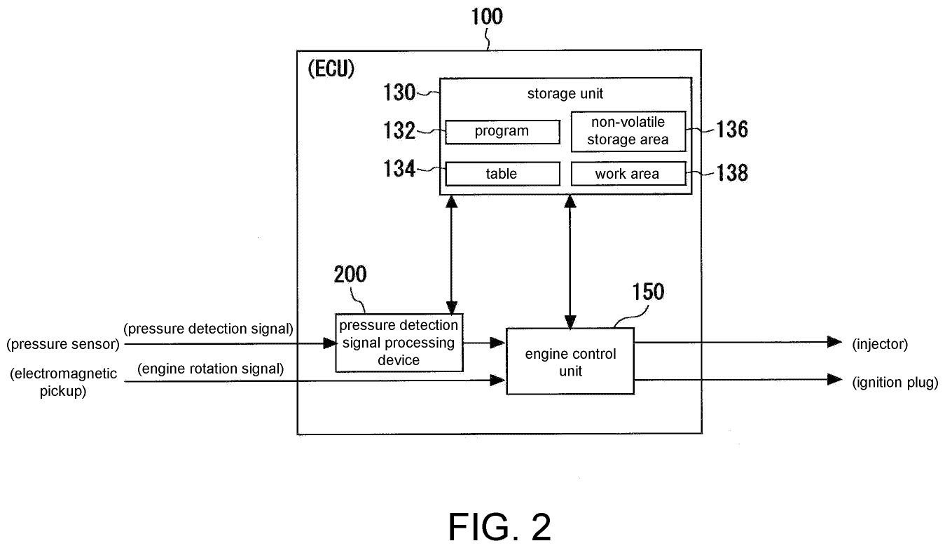

FIG. 2 is a function configuration diagram showing functions of the ECU 100. The ECU 100 includes a storage unit 130, an engine control unit 150, and the pressure detection signal processing device 200. The storage unit 130 has a program 132, a table 134, a non-volatile storage area 136, and a work area 138. The work area 138 is a temporary storage region for temporarily storing various parameters in a computation process and the like, and the non-volatile storage area 136 is a storage region for non-volatilely storing various parameters used in the computation.

The engine control unit 150 calculates the fuel injection amount based on the pressure detection signal which is output from the pressure detection signal processing device 200, and the like, and controls the injector 40 by using a fuel injection signal corresponding to the calculated fuel injection amount at the timing based on the engine rotation signal from the electromagnetic pickup 22. Accordingly, the injector 40 injects the fuel with the fuel injection amount corresponding to the control from the engine control unit 150.

The engine control unit 150 determines the ignition time based on the engine rotation signal from the electromagnetic pickup 22 and controls the ignition plug. In addition, the engine control unit 150 can also control the ignition time based on the pressure detection signal from the pressure detection signal processing device 200 in addition to the engine rotation signal from the electromagnetic pickup 22.

The function configuration of the ECU 100 shown in FIG. 2 is just an example. The ECU 100 may have other function configurations. The pressure detection signal after the signal processing, which is output from the pressure detection signal processing device 200, can be applied not only to the fuel injection control and the ignition time control, but also to detection and control of various parameters, such as knocking detection, misfire detection, combustion speed computation, and the like.

(Configuration of Pressure Detection Signal Processing Device 200)

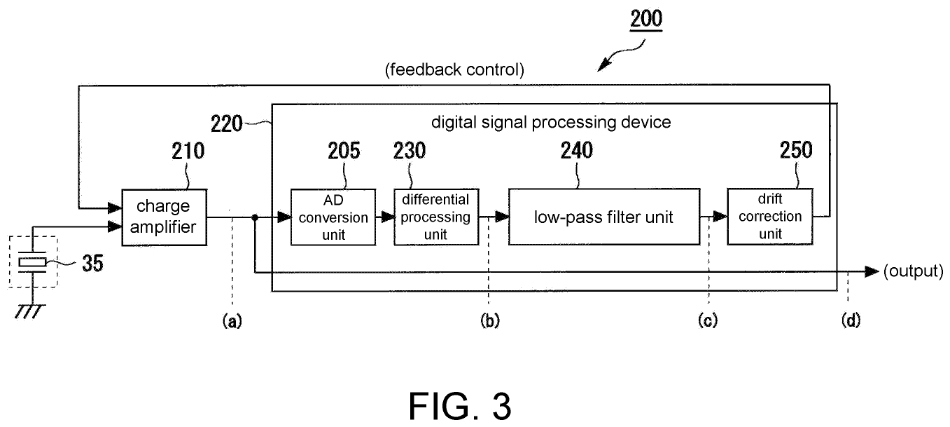

FIG. 3 is a configuration diagram of the pressure detection signal processing device 200. The pressure detection signal processing device 200 has a charge amplifier 210 and a digital signal processing unit 220. The digital signal processing unit 220 has an AD conversion unit 205, a differential processing unit 230, a low-pass filter unit 240, and a drift correction unit 250, and a correction signal from the drift correction unit 250 is fed back to an input side of the charge amplifier 210. In addition, output of the charge amplifier 210 becomes an output signal to the digital signal processing device 220.

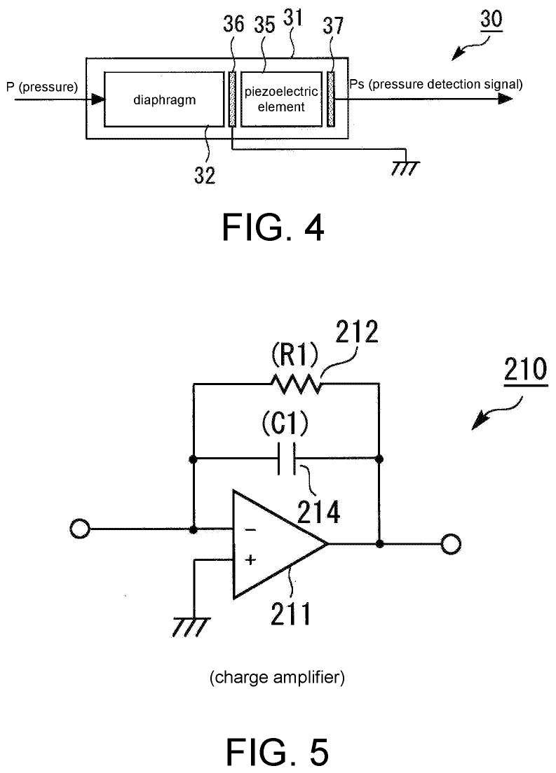

FIG. 4 is a schematic configuration diagram of the pressure sensor 30. A diaphragm 32 which receives a pressure signal P and a piezoelectric element 35 which is clamped between a pair of electrodes 36 and 37 are incorporated in a tubular housing 31 of the pressure sensor 30. A grounded lead wire is connected to the electrode 36, and a lead wire for transmitting a pressure detection signal Ps of the pressure sensor 30 to the next stage is connected to the other electrode 37. The piezoelectric element 35 produces and outputs an electric charge corresponding to pressure receiving strength. The piezoelectric element 35 is configured by, for example, a dielectric material such as zinc oxide (ZnO) or the like.

When the diaphragm 32 applies the pressure to the piezoelectric element 35 according to the pressure receiving strength, the piezoelectric element 35 produces the electric charge corresponding to the applied pressure and outputs the electric charge to the charge amplifier 210 of the next stage. In this way, the electric charge corresponding to the pressure P is transmitted to the charge amplifier 210 as the pressure detection signal Ps.

FIG. 5 is a configuration diagram of the charge amplifier (an electric current amplifier) 210. The charge amplifier 210 has a configuration in which a parallel circuit is in negative feedback connection with the operational amplifier 211, and a resistor 212 having a resistance value R1 and a capacitor 214 having a capacitance value C1 are connected in parallel in the parallel circuit. A non-inverting terminal of the operational amplifier 211 is grounded and comes into a virtual ground state. In addition, the charge amplifier 210 may have a configuration in which only the capacitor 214 is in negative feedback connection to the operational amplifier 211.

Because input impedance of the operational amplifier 211 is ideally infinite, the electric charge from the piezoelectric element 35 is accumulated in the capacitor 214, and a voltage corresponding to the accumulation electric charge is produced on both sides of the capacitor 214. In this way, the charge amplifier 210 accumulates the electric charge produced in the piezoelectric element 35 and outputs a corresponding voltage signal V (Q=C1·V (“Q” is an electric charge, and “V” is an output voltage).

In addition, an analog output signal from the charge amplifier 210 is input to the AD conversion unit 205 shown in FIG. 3, and the AD conversion unit 205 converts the input signal into a digital signal. The differential processing unit 230 performs differential processing on the digital signal obtained through the analog-to-digital conversion performed by the AD conversion unit 205. In the differential processing performed by the differential processing unit 230, a slope of the signal input to the differential processing unit 230 is sequentially calculated.

If a digital sampling period by the AD conversion unit 205 is set to “T”, and the signals in a time lapse “T, 2·T, 3·T, . . . , (n−1)·T, n·T” are set to “y(1), y(2), y(3), . . . , y(n−1), y(n)”, the differential processing is achieved by calculating “y(2)−y(1), y(3)−y(2), . . . , y(n)−y(n−1)”. That is, the differential processing performed by the differential processing unit 230 corresponds to sequentially calculating a difference between the digital signals.

The low-pass filter unit 240 extracts a drift component of the differential signal which has been subjected to the differential processing of the differential processing unit 230. The low-pass filter unit 240 can be achieved by a low-pass filter which extracts the drift component changing slowly in the differential signal. As an example of the low-pass filter, a “moving average filter” can be adopted. When the digital sampling period is set to “T”, and the signals in the time lapse “T, 2·T, 3·T, . . . , (n−1)·T, n·T” are set to “y(1), y(2), y(3), . . . , y(n−2), y(n−1), y(n)”, the “moving average filter” can be achieved by calculating “(y(1)+y(2)+y(3))/3, . . . , (y(n−2)+y(n−1)+y(n))/3”. In this way, the differential processing unit 230 and the low-pass filter unit 240 cooperate to function as a drift component extraction unit which extracts the drift component of the piezoelectric element.

That is, the moving average filter sequentially calculates an average value in n (n is an integer of 3 or more) digital signals before and after the digital signal of interest. If the value of n is set to a great value, a cut-off frequency can be lowered.

For example, stable signal processing can be achieved regardless of a peak value by linearly changing the value of n of the moving average filter according to the engine rotation speed.

More specifically, as an example, the engine rotation speed and n can be set to be proportional to each other. In addition, the engine rotation speed can be calculated from the combustion pressure which is shown by the pressure detection signal subjected to the signal processing by the pressure detection signal processing device 200. In addition, the engine rotation speed may be acquired from the engine control unit 150 by inputting the engine rotation signal acquired by the engine control unit 150 to the pressure detection signal processing device 200.

The drift correction unit 250 outputs the correction signal to be fed back to the input side of the charge amplifier 210. More specifically, the drift correction unit 250 performs a digital-to-analog conversion on the voltage signal corresponding to a difference between a target value set previously and the extraction signal of the low-pass filter unit 240, and performs feedback control for adding, to the input side of the charge amplifier 210, the electric current signal corresponding to the analog voltage signal after the digital-to-analog conversion as the correction signal.

(Digital Signal Processing Unit of “First Embodiment”)

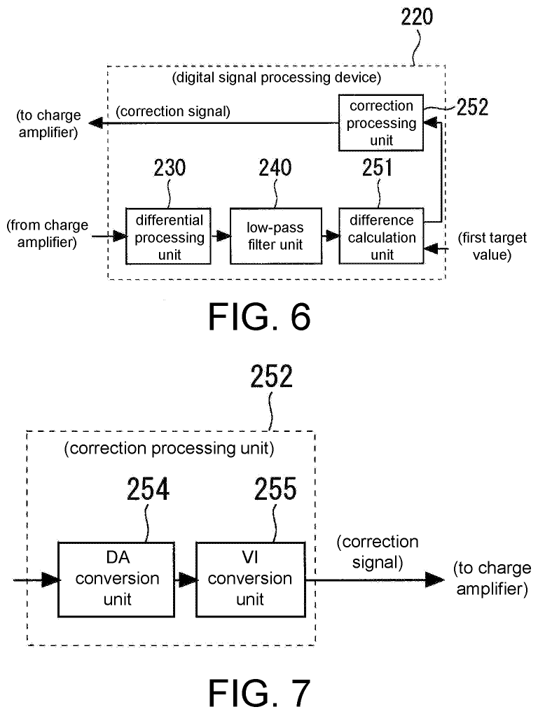

FIG. 6 shows a first embodiment of the digital signal processing unit 220. The first embodiment is characterized in that the drift is removed only by differential control (D control). In addition, in the following description, the AD conversion unit 205 which is arranged in the front stage of the digital signal processing unit 220 and described in FIGS. 6, 8 and 9 is omitted.

The digital signal processing unit 220 shown in FIG. 6 has a differential processing unit 230, a low-pass filter unit 240, a difference calculation unit 251, and a correction processing unit 252. The drift correction unit 250 shown in FIG. 3 corresponds to the difference calculation unit 251 and the correction processing unit 252.

Besides, the low-pass filter unit 240 outputs, to the difference calculation unit 251, the extraction signal which is obtained by extracting the drift component based on the differential signal output from the differential processing unit 230. The difference calculation unit 251 calculates a difference between a first target value set previously and the extraction signal and outputs the difference to the correction processing unit 252.

FIG. 7 is a configuration diagram of the correction processing unit 252 of the first embodiment. The correction processing unit 252 has a DA conversion unit 254 and a VI conversion unit 255. The DA conversion unit 254 performs the digital-to-analog conversion on the difference signal which is output from the difference calculation unit 251, and outputs the difference signal to the VI conversion unit 255. The VI conversion unit 255 performs a voltage-current conversion (VI conversion) on the difference signal which has been subjected to the digital-to-analog conversion, and adds the electric current signal after the voltage-current conversion as the correction signal to the input side of the charge amplifier 210.

That is, the difference signal is subjected to the digital-to-analog conversion by the DA conversion unit 254, and the VI conversion unit 255 VI-converts the difference signal into the electric current signal corresponding to the digitally converted voltage signal, and outputs the electric current signal to the charge amplifier 210.

In this way, the digital signal processing unit 220 of the first embodiment shown in FIG. 6 performs the feedback control by the differential control (D control: Differential control) by the differential processing unit 230, the difference calculation unit 251, and the correction processing unit 252.

(Digital Signal Processing Unit of “Second Embodiment”)

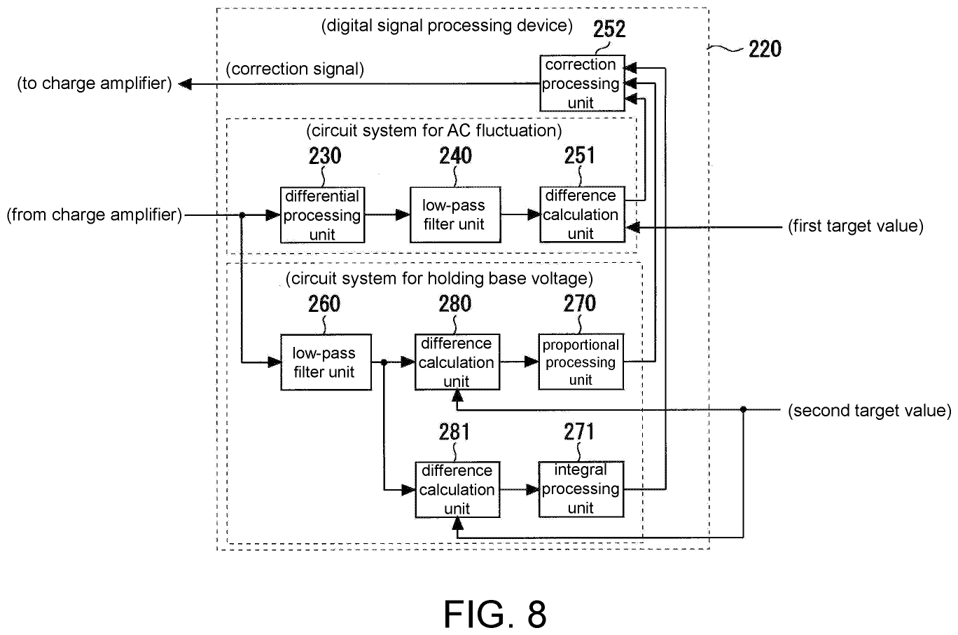

FIG. 8 shows a second embodiment of the digital signal processing unit 220. The second embodiment is characterized in that the drift is removed by PID control including the differential control (D control), proportional control (P control: Proportional control), and integral control (I control: Integral control), and a baseline is kept steady.

The digital signal processing unit 220 shown in FIG. 8 further has, in the first embodiment shown in FIG. 6, a low-pass filter unit 260, a difference calculation unit 280, a difference calculation unit 281, a proportional processing unit 270, and an integral processing unit 271.

The low-pass filter unit 260 outputs the signal which is obtained by extracting a component in a predetermined low frequency band of the voltage signal which is output from the charge amplifier 210. The difference calculation unit 280 calculates a difference between a second target value set previously and the output signal of the low-pass filter unit 260, and outputs a difference signal showing the calculated difference to the proportional processing unit 270. Similarly, the difference calculation unit 281 calculates the difference between the second target value set previously and the output signal of the low-pass filter unit 260, and outputs the difference signal showing the calculated difference to the integral processing unit 271. Moreover, the differential processing unit 230, the low-pass filter 240, and the difference calculation unit 251 shown in FIG. 8 are the same as those shown in FIG. 6.

The proportional processing unit 270 outputs, to the correction processing unit 252, a signal which is obtained by multiplying the difference signal output from the difference calculation unit 280 by a proportionality constant. The integral processing unit 271 outputs, to the correction processing unit 252, an integral signal which is obtained by performing integral processing on the difference signal output from the difference calculation unit 281. Moreover, the output of the difference calculation unit 280 can also be used as the input of the integral processing unit 271, and the output of the difference calculation unit 281 can also be used as the input of the proportional processing unit 270. In this case, only one of the difference calculation unit 280 and the difference calculation unit 281 may be arranged.

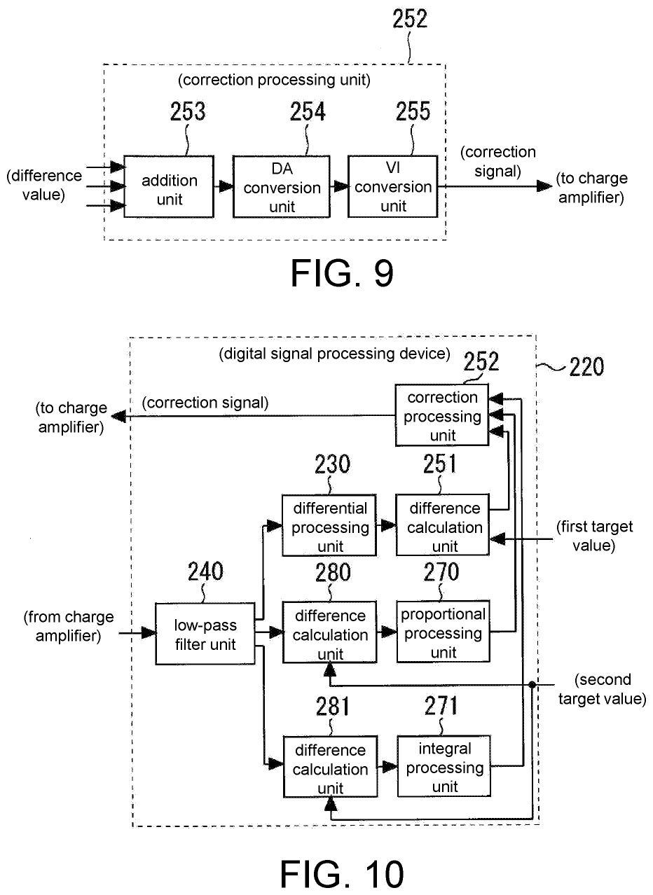

FIG. 9 is a configuration diagram of the correction processing unit 252 of the second embodiment. The correction processing unit 252 has an addition unit 253, the DA conversion unit 254, and the VI conversion unit 255. The addition unit 253 adds the input signals to obtain an addition signal, and the DA conversion unit 254 performs the digital-to-analog conversion on the addition signal and outputs the addition signal to the VI conversion unit 255. The VI conversion unit 255 performs the voltage-current conversion (VI conversion) on the addition signal subjected to the digital-to-analog conversion, and adds the electric current signal after the voltage-current conversion as the correction signal to the input side of the charge amplifier 210.

The correction processing unit 252 adds the signals from the difference calculation unit 251, the proportional processing unit 270, and the integral processing unit 271 to calculate the addition signal, performs the digital-to-analog conversion on the calculated addition signal, and feeds the electric current signal, which is obtained by

VI-converting the signal subjected to the digital-to-analog conversion, back to the input side of the charge amplifier 210 as the correction signal.

Moreover, when the digital sampling period is set to “T”, and the signals in the time lapse “T, 2·T, 3·T, . . . , (n−1)·T, n·T” are set to “y(1), y(2), y(3), . . . , y(n−1), y(n)”, the integral processing is achieved by calculating “y(1)·T, y(1)·T+y(2)·T, y(1)·T+y(2)·T+y(3)·T, . . . , y(1)·T+y(2)·T+y(3)·T+ . . . +y(n)·T”. That is, the integral processing performed by the integral processing unit 271 corresponds to sequentially calculating the total sum of the digital signals.

In this way, the digital signal processing unit 220 of the second embodiment shown in FIG. 8 performs, in addition to the feedback control by the differential control (D control), the feedback control by the proportional control (P control) and the integral control (I control) by the proportional processing unit 270, the integral processing unit 271, the difference calculation unit 280, the difference calculation unit 281, and the correction processing unit 252. Therefore, in addition to the differential control (D control), the proportional control (P control) and the integral control (I control) are performed, and thus convergence to the target value can be quick, and controllability can be further improved.

A “circuit system for AC fluctuation” consisting of the differential processing unit 230 and the difference calculation unit 251 has an action of removing the drift component which fluctuates in an AC manner, and a “circuit system for holding base voltage” consisting of the proportional processing unit 270, the integral processing unit 271, the difference calculation unit 280, and the difference calculation unit 281 has an action of holding the baseline which is a base voltage of the pressure detection signal.

(Digital Signal Processing Unit of “Third Embodiment”)

FIG. 10 shows a third embodiment of the digital signal processing unit 220. The third embodiment is characterized in that signal processing is performed by one low-pass filter unit 240. The digital signal processing unit 220 shown in FIG. 10 has the low-pass filter unit 240, the differential processing unit 230, the difference calculation unit 251, the difference calculation unit 280, the difference calculation unit 281, the proportional processing unit 270, the integral processing unit 271, and the correction processing unit 252. In the configuration of FIG. 10, the output of the difference calculation unit 280 can also be used as the input of the integral processing unit 271, and the output of the difference calculation unit 281 can also be used as the input of the proportional processing unit 270. In this case, only one of the difference calculation unit 280 and the difference calculation unit 281 may be arranged.

The low-pass filter unit 240 outputs the extraction signal which is obtained by extracting the drift component based on the voltage signal of the charge amplifier 210. The differential processing unit 230 outputs the differential signal obtained by performing the differential processing on the extraction signal to the difference calculation unit 251. In addition, the proportional control unit 270 outputs the proportional signal obtained by multiplying the input signal by the proportionality constant to the correction processing unit 252. The integral processing unit 271 outputs the integral signal obtained by performing the integral processing on the input signal to the correction processing unit 252.

The difference calculation unit 251 calculates the difference between the first target value set previously and the output signal of the differential processing unit 230, and outputs the difference signal showing the calculated difference to the correction processing unit 252. Similarly, the difference calculation unit 280 calculates the difference between the second target value set previously and the output signal of the low-pass filter unit 240, and outputs the difference signal showing the calculated difference to the proportional processing unit 270. The difference calculation unit 281 calculates the difference between the second target value set previously and the output signal of the low-pass filter unit 240, and outputs the difference signal showing the calculated difference to the integral processing unit 271.

The addition unit 253 of the correction processing unit 252 shown in FIG. 9 calculates the addition signal which is obtained by adding three types of the signals respectively output from the difference calculation unit 251, the proportional processing unit 270, and the integral processing unit 271. Then, the DA conversion unit 254 performs the digital-to-analog conversion on the addition signal, and then the VI conversion unit 255 feeds the electric current signal, which is obtained by VI-converting the addition signal subjected to the digital-to-analog conversion, back to the input side of the charge amplifier 210 as the correction signal.

In this way, the feedback control including the differential control (D control), the proportional control (P control), and the integral control (I control) can be performed by a simple configuration in which one low-pass filter is used for the extraction of the drift component and the extraction of the baseline.

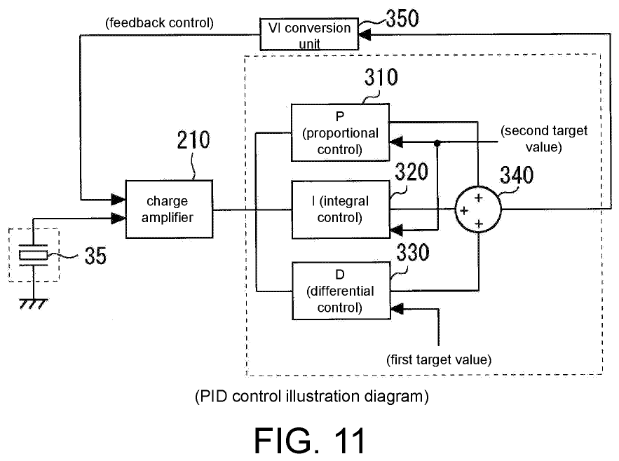

FIG. 11 is an illustration diagram of summary of the PID control applied to the present invention. The output signal of the charge amplifier 210 is subjected to each of the proportional processing, the integral processing, and the differential processing respectively by a P control unit 310, an I control unit 320, and a D control unit 330. The P control unit 310 outputs, to the addition unit 340, the proportional signal obtained by performing the proportional processing on the difference between the second target value and the output signal of the charge amplifier 210.

Similarly, the I control unit 320 outputs, to the addition unit 340, the integral signal obtained by performing the integral processing on the difference between the second target value and the output signal of the charge amplifier 210, and the D control unit 330 outputs, to the addition unit 340, the difference signal showing the difference between the first target value and the differential signal which is obtained by performing the differential processing on the output signal of the charge amplifier 210. The adder 340 adds each signal and outputs the addition signal showing the addition result to the VI conversion unit 350.

Next, the VI conversion unit 350 feeds the electric current signal, which is obtained by VI-converting the addition signal, back to the input side of the charge amplifier 210 as the correction signal. The pressure detection signal can be acquired in which the drift component is removed by performing the differential control and the baseline is kept steady regardless of the influence of atmospheric pressure by performing the proportional control and the integral control, and the pressure detection signal is included in the processing of the ECU 100 and the like. In this way, a highly precise pressure detection signal can be acquired by the PID control.

In the P control unit 310, a multiplication signal obtained by multiplying the difference between the output of the charge amplifier 210 and the second target value by a proportional control gain (Kp) is output to the addition unit 340. Similarly, the I control unit 320 and the D control unit 330 may have a configuration in which each of the corresponding integral signal and the corresponding difference signal are further multiplied by an integral gain (Ki) and a differential gain (Kd), and are output to the addition unit 340. At this time, “Ki” and “Kd” can also be constants other than “1.0”. In order to improve the controllability such as responsiveness of the control system and the like, the “integral gain: Ki” and the “differential gain: Kd” can be appropriately adjusted. The gain adjustment method may be, for example, a Ziegler-Nichols'

### Ultimate Gain Method.

(Operation)

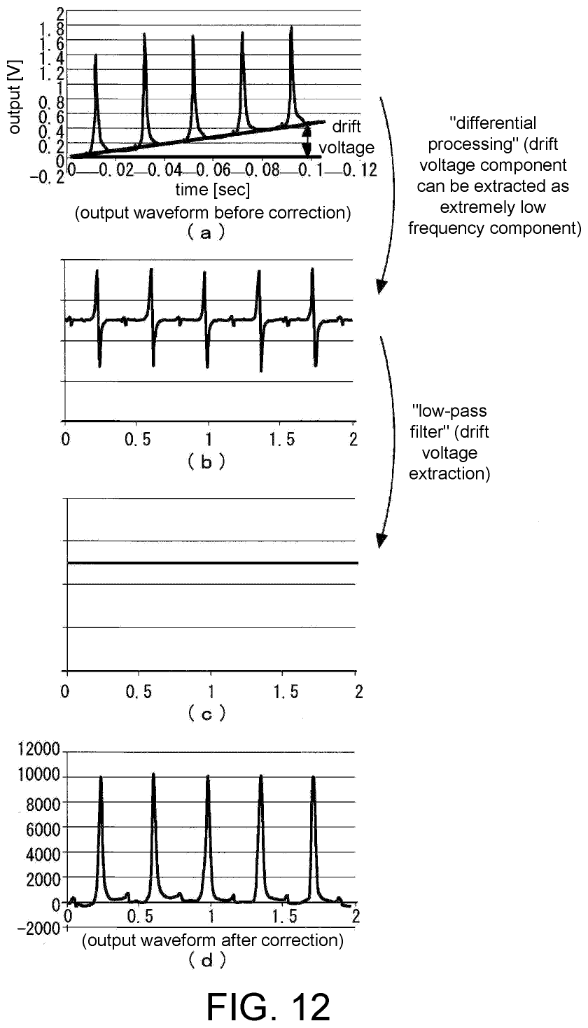

Then, operations of the digital signal processing unit 220 are described with reference to FIG. 12. FIG. 12(a) shows an output signal from the charge amplifier 210 (a signal at a position of a reference numeral “a” in FIG. 3). The output signal of the charge amplifier 210 contains an integrated drift component and changes over time (the signal at the position of the reference numeral “a” in FIG. 3).

Next, when the differential processing unit 230 performs the differential processing on the signal shown in FIG. 12(a), the signal becomes a signal shown in FIG. 12(b) (a signal at a position of a reference numeral “b” in FIG. 3). The drift component can be extracted by the action of the differential processing unit 230. That is, the drift component before the integration can be extracted by performing the differential processing.

Next, the low-pass filter unit 240 attenuates a frequency component higher than the cut-off frequency in the signal shown in FIG. 12(b), and obtains a signal which is extremely fine and fluctuates in an AC manner centered on the baseline (see FIG. 12(c): a signal at a position of a reference numeral “c” in FIG. 3).

Next, the difference calculation unit 251 extracts the drift component as a difference between the first target value and the signal shown in FIG. 12(c). Here, for example, “0 V” is set as the first target value. Besides, FIG. 12(d) shows a signal when the correction processing unit 252 obtains, based on the extraction signal showing the drift component, a correction signal for performing the feedback control, and feeds the obtained correction signal back to the input side of the charge amplifier 210 (a signal at a position of a reference numeral “d” in FIG. 3). According to the signal shown in FIG. 12(d), it can be seen that the drift component is removed.

In addition, in the proportional processing performed by the proportional processing unit 270 and the integral processing performed by the integral processing unit 271, the baseline voltage of the output signal from the charge amplifier 210 is corrected so as to be the set second target value. For example, when the second target value is set to “0.5 (V)”, the baseline voltage of the output signal from the charge amplifier 210 becomes “0.5 (V)”. Moreover, parameters such as the first target value, the second target value, and the like which are necessary for the PID control are stored non-volatilely in advance in, for example, a non-volatile memory 136.

According to the embodiment described above, the charge amplifier 210 accumulates the electric charge produced by the piezoelectric element 35 corresponding to the received pressure and outputs the corresponding voltage signal, and the differential processing unit 230 outputs the differential signal obtained by performing the differential processing on the voltage signal. Furthermore, the low-pass filter unit 240 extracts the drift component based on the differential signal.

Then, the drift correction unit 250 obtains a correction electric current signal for reducing the extracted drift component and feeds back the obtained electric current signal as the correction signal to the input side of the charge amplifier 210. Therefore, the drift of the piezoelectric element 35 can be removed, and the highly precise pressure detection signal can be obtained.

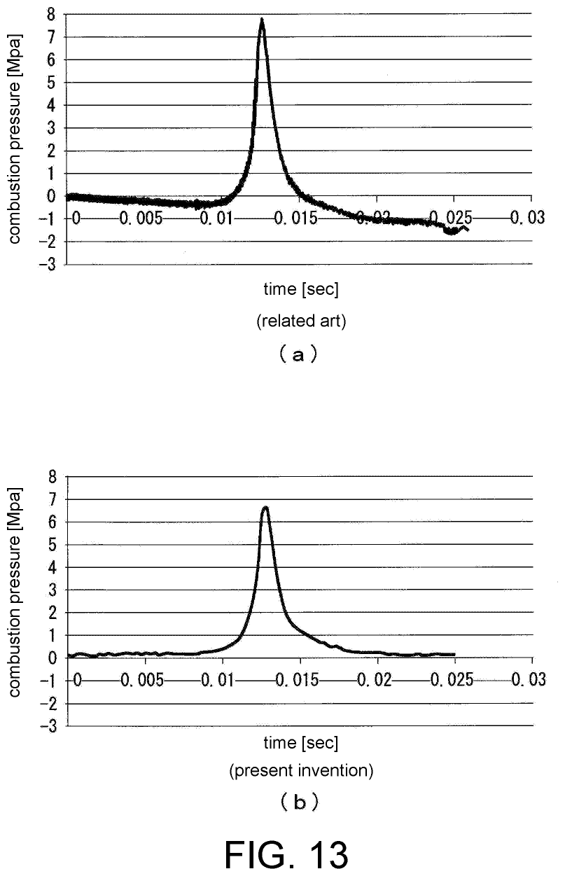

FIG. 13 is a comparative example between a pressure detection signal of a conventional example and the pressure detection signal subjected to the signal processing of the present invention. FIG. 13(a) is a graph showing an output signal from a conventional pressure sensor 30, in which the “horizontal axis” is time (sec) and the “vertical axis” is combustion pressure (Mpa). As can be seen with reference to FIG. 12(a), the conventional pressure detection signal has drift of the piezoelectric element 35, and thus the baseline changes over time.

On the other hand, FIG. 13(b) is a graph showing the pressure detection signal subjected to the signal processing of the present invention, in which the “horizontal axis” is time (sec) and the “vertical axis” is combustion pressure (Mpa). As can be seen with reference to FIG. 13(b), in the pressure detection signal to which the present invention is applied, the baseline does not change over time. That is, a highly precise pressure detection signal can be obtained in which the drift component is removed and the baseline is kept steady. According to the pressure detection signal after the application of the present invention, a variety of signal processing of a post-step in the ECU 100 or the like becomes easy.

The pressure detection signal processing device 200 described above can be achieved by, foe example, a programmable logic device (PLD) such as a field programmable gate array (FPGA) or the like. In addition, a CPU may also function as the digital signal processing unit 220 by executing the program 132 stored in the storage unit 130.

In addition, it is confirmed that when the input exceeds a predetermined level between the front stage of “the differential processing unit 230 and the low-pass filter unit 260” and the charge amplifier 210, if a slice unit is arranged which has a slice function of suppressing the signal of the exceeding part to the predetermined level, stable drift extraction can be performed regardless of the peak value. The slice unit can be achieved by, for example, a circuit element such as a Zener diode or the like, or can be achieved by a program for executing clipping processing or the like.

In addition, according to the pressure detection signal processing device 200 of the present invention, the pressure detection signal in the ECU 100 or the like can be processed with high precision, and thus the engine control can be performed with high precision based on the output signal from the pressure detection signal processing device 200.

In addition, the configuration of the correction processing unit 252 and the like described above are only examples. For example, the difference and the corresponding electric current value may be associated and registered in the table 134 in advance, and the correction processing unit 252 may have an electric current control unit. Besides, a configuration or the like may also be adopted in which one or more variable electric current sources are subjected to operation control in a manner that the electric current control unit reads an electric current value corresponding to the difference calculated by the difference calculation units 251, 280, and 281 from the table 134, and feeds the correction signal which is the read electric current value back to the input side of the charge amplifier. At this time, the table 134 may be constructed for each difference calculation unit. In addition, the addition value and the corresponding electric current value may be associated and registered in the table 134 in advance, and the electric current control unit may feed the correction signal, which is the electric current value corresponding to the addition value shown by the addition signal from the addition unit 253, back to the input side of the charge amplifier. In addition, the difference or the addition value, and the voltage value may be associated and registered in the table 134 in advance, and the electric current control unit may read the voltage value corresponding to the difference or the addition value from the table 134, and output the voltage signal which is the read voltage value to the DA conversion unit 254.

Furthermore, in the above description, in particular, the configuration example with respect to the pressure detection signal showing the pressure inside the combustion chamber of the engine 1 is shown, but the present invention can also be applied to a pressure detection signal of not only a gas, but also another pressure receiving medium such as a fluid or the like. In addition, the engine control system 300 in FIG. 1 has a configuration in which the pressure detection signal processing device 200 is arranged inside the ECU 100, but the engine control system 300 may have a system configuration in which the ECU 100 and the pressure detection signal processing device 200 are separately arranged and the pressure detection signal is supplied to the ECU 100.

In addition, in the above description, the configuration example in which the low-pass filter units 240 and 260 are included is described, but the present invention is not limited hereto, and a configuration without the low-pass filter units 240 and 260 is possible. However, preferably, as described above, in the configuration including the low-pass filter units 240 and 260, by removing the high-frequency component according to the pressure fluctuation, the drift voltage and the baseline voltage can be extracted with higher precision, and the feedback control can be performed with higher precision.

Besides, a processor such as a CPU, a DSP (Digital Signal Processor) or the like executes the program, and thereby the processing function, the extraction function, the correction function, the difference calculation function, the correction processing function and the like are achieved. Furthermore, the present invention can also provide a non-temporary recording medium on which the program is recorded. The non-temporary recording media which records the program may be a semiconductor element such as an ROM or the like, an optical element such as a CD, a DVD or the like, and a magnetic element such as a magnetic disk or the like. The recording medium is available as long as the recording medium can be executed on a computer in a way of reading the program stored in the recording medium by a reading means, and the type and the like of the recording medium are not limited.

### REFERENCE SIGNS LIST

1 engine

15 combustion chamber

30 pressure sensor

32 diaphragm

35 piezoelectric element

36, 37 electrode

100 ECU

200 pressure detection signal processing device

210 charge amplifier

211 operational amplifier

212 resistor

214 capacitor

205 AD conversion unit

220 digital signal processing unit

230 differential processing unit

240 low-pass filter unit

250 drift correction unit

251 difference calculation unit

252 correction processing unit

260 low-pass filter unit

270 proportional processing unit

271 integral processing unit

300 engine control system

1. A pressure detection signal processing device which performs signal processing on an output signal of a pressure sensor that comprises a piezoelectric element producing an electric charge corresponding to a received pressure, comprising:
a charge amplifier which accumulates the electric charge and outputs a corresponding voltage signal;
a drift component extraction unit which extracts a drift component of the piezoelectric element by performing differential processing on the voltage signal; and
a drift correction unit which generates a correction signal for removing the extracted drift component and feeds the correction signal back to an input side of the charge amplifier.

2. The pressure detection signal processing device according to claim 1, wherein
the drift component extraction unit comprises:
a differential processing unit which performs the differential processing on the voltage signal; and
a low-pass filter which extracts a component in a predetermined low frequency band of the signal subjected to the differential processing.

3. The pressure detection signal processing device according to claim 1, wherein
the drift correction unit comprises:
a first difference calculation unit which calculates a first difference between a first target value set previously and the extracted drift component; and
a correction processing unit which generates the correction signal corresponding to the first difference and feeds the correction signal back to the input side of the charge amplifier.

4. The pressure detection signal processing device according to claim 3, further comprising:
a second low-pass filter which extracts a signal showing a component in a predetermined low frequency band of the voltage signal;
a second difference calculation unit which calculates a second difference between a second target value set previously and the signal extracted by the second low-pass filter; and
a proportional processing unit which outputs a proportional signal obtained by performing proportional processing on the second difference, wherein
the correction processing unit generates the correction signal corresponding to an addition signal obtained by adding the proportional signal to the first difference and feeds the correction signal back to the input side of the charge amplifier.

5. The pressure detection signal processing device according to claim 4, further comprising:
a third difference calculation unit which calculates a third difference between the second target value and the signal extracted by the second low-pass filter; and
an integral processing unit which outputs an integral signal obtained by performing integral processing on the third difference, wherein
the correction processing unit generates the correction signal corresponding to an addition signal obtained by adding the first difference, the proportional signal, and the integral signal, and feeds the correction signal back to the input side of the charge amplifier.

6. The pressure detection signal processing device according to claim 1, wherein
a slice unit which suppresses an input signal exceeding a predetermined value to the predetermined value is arranged in a front stage of the differential processing unit and/or a front stage of the second low-pass filter.

7. The pressure detection signal processing device according to claim 1, wherein
the drift component extraction unit comprises:
a low-pass filter which extracts a signal showing a component in a predetermined low frequency band of the voltage signal, and
a differential processing unit which outputs a differential signal obtained by performing differential processing on the signal extracted by the low-pass filter;
the drift correction unit comprises:
a first difference calculation unit which calculates a first difference between a first target value set previously and the differential signal, and
a correction processing unit which generates the correction signal and feeds the correction signal back to an input side of the charge amplifier;
the pressure detection signal processing device comprises:
a second difference calculation unit which calculates a second difference which is a difference between a second target value set previously and the signal extracted by the low-pass filter,
a proportional processing unit which outputs a proportional signal obtained by performing proportional processing on the second difference, and
an integral processing unit which outputs an integral signal obtained by performing integral processing on the second difference; and
the correction processing unit generates the correction signal corresponding to an addition signal obtained by adding the first difference, the proportional signal, and the integral signal.

8. The pressure detection signal processing device according to claim 1, wherein
the charge amplifier comprises
an operational amplifier which is in negative feedback connection to a parallel circuit including a resistor and a capacitor or in negative feedback connection to a capacitor.

9. An engine control system, comprising:
the pressure detection signal processing device according to claim 1, and
a control unit which controls an engine based on an output signal from the pressure detection signal processing device.

10. The pressure detection signal processing device according to claim 2, wherein
a digital signal processing unit changes, according to a rotation speed of the engine, a cut-off frequency of the low-pass filter constituting the drift component extraction unit.

11. A non-transitory computer readable recording medium storing a program for achieving, in a pressure detection signal processing device which performs signal processing on an output signal of a pressure sensor comprising a piezoelectric element producing an electric charge corresponding to a received pressure,
an extraction function for extracting a drift component of the piezoelectric element by performing differential processing on a voltage signal from a charge amplifier which accumulates the electric charge and outputs the corresponding voltage signal; and
a correction function for generating a correction signal for removing the extracted drift component, and feeding the correction signal back to an input side of the charge amplifier.

12. The non-transitory computer readable recording medium according to claim 11, wherein
the correction function comprises:
a difference calculation function for calculating a difference between a target value set previously and the drift component extracted by the extraction function; and
a correction processing function for feeding the correction signal corresponding to the difference back to the input side of the charge amplifier.
